(19) United States
(12) Patent Application Publication
(10) Pub. No.: US 2023/0179731 A1
(43) Pub. Date: Jun. 8, 2023

(54) IMAGE PROCESSING APPARATUS

(71) Applicant: KYOCERA Document Solutions Inc., Osaka (JP)

(72) Inventor: Seiki Satomi, Oska (JP)

(21) Appl. No.: 18/059,080

(22) Filed: Nov. 28, 2022

(30) Foreign Application Priority Data
Dec. 2, 2021 (JP) 2021-196443

(51) Int. Cl. H04N 5/073; H04N 5/262; G06T 3/40

(52) U.S. Cl. CPC H04N 5/0736; H04N 5/2628; G06T 3/4007

(57) ABSTRACT

An input circuit writes image data into a line buffer. An output circuit reads pixel data of a pixel to be sampled among the pixel data, the pixel specified correspondingly to a shrinking ratio. Further, with a throughput obtained by multiplying a throughput of the output circuit by a square of an inverse number of the shrinking ratio, the input circuit skips another pixel than the pixel to be sampled among the pixel data of an input block of a predetermined size that extends over lines of an inverse number of the shrinking ratio, and writes the pixel data into the line buffer. Upon writing pixel data of an adjacent input block of the input block in a secondary scanning direction into the line buffer, the output circuit reads from the line buffer the pixel data of the pixel to be sampled and continuously outputs the pixel data.

### CROSS-REFERENCE TO RELATED APPLICATIONS

This application relates to and claims priority rights from Japanese Patent Application No. 2021-196443, filed on Dec. 2, 2021, the entire disclosures of which are hereby incorporated by reference herein.

### BACKGROUND

### 1. Field of the Present Disclosure

The present disclosure relates to an image processing apparatus.

### 2. Description of the Related Art

An image processing apparatus performs a shrinking process of an image using a line buffer.

FIG. 4 shows a diagram that explains a general actual size operation and a general shrinking operation using a line buffer. FIG. 5 shows a timing chart that explains a general shrinking operation using a line buffer.

For example, when shrinking an image by half in both vertical and horizontal directions, one pixel of output is sampled per two-by-two pixels of input. In such a case, as shown in FIG. 4, for example, for one line in an input image block obtained by dividing a target image, (a) data of every four pixels in the line is written into a line buffer as input stream data in turn.

For example, as shown in FIG. 4, in an actual size operation, data of each pixel written in the line buffer is read from the line buffer. In a shrinking operation, among the pixel data written in the line buffer, pixel data of only a pixel to be sampled is read from the line buffer. Therefore, as shown in FIG. 5, for example, in line output, a suspension period appears due to a line including a pixel not to be sampled in the input image block.

### SUMMARY

An image processing apparatus according to an aspect of the present disclosure includes a line buffer, an input circuit, and an output circuit. The input circuit is configured to write image data into the line buffer. The output circuit is configured to read pixel data of a pixel to be sampled among the pixel data, the pixel specified correspondingly to a shrinking ratio. Further, with a throughput obtained by multiplying a throughput of the output circuit by a square of an inverse number of the shrinking ratio, the input circuit skips another pixel than the pixel to be sampled among the pixel data of an input block of a predetermined size that extends over lines of an inverse number of the shrinking ratio, and writes pixel data of the pixel to be sampled into the line buffer. Upon writing pixel data of an adjacent input block of the input block in a secondary scanning direction into the line buffer, the output circuit reads from the line buffer the pixel data of the pixel to be sampled and continuously outputs the pixel data.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an image processing apparatus according to an embodiment of the present disclosure;

FIG. 2 shows a diagram that explains an actual size operation and a shrinking operation using a line buffer in the image processing apparatus shown in FIG. 1;

FIG. 3 shows a timing chart that explains a shrinking operation using a line buffer in the image processing apparatus shown in FIG. 1;

FIG. 4 shows a diagram that explains a general actual size operation and a general shrinking operation using a line buffer; and

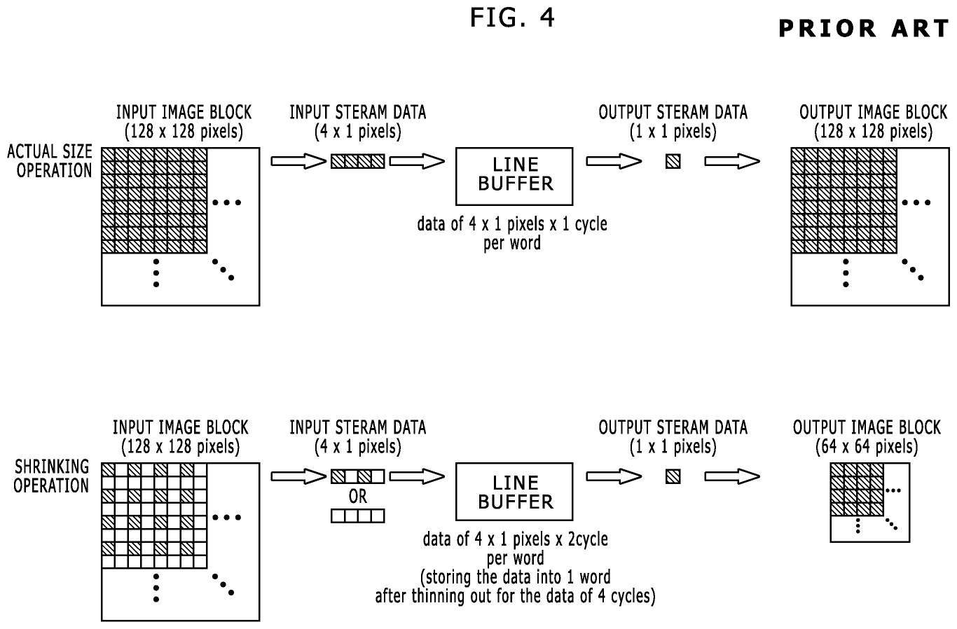

FIG. 5 shows a timing chart that explains a general shrinking operation using a line buffer.

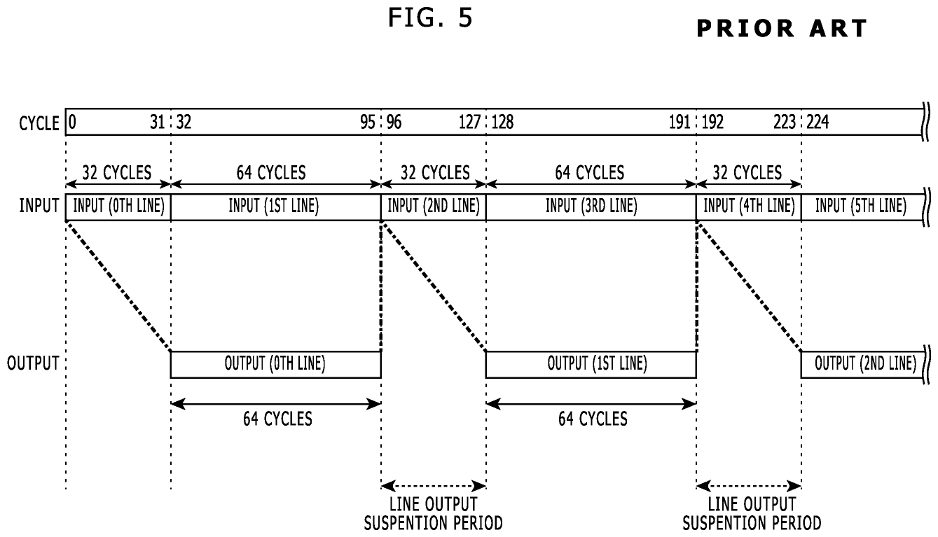

### DETAILED DESCRIPTION

Hereinafter, an embodiment according to an aspect of the present disclosure will be explained with reference to drawings.

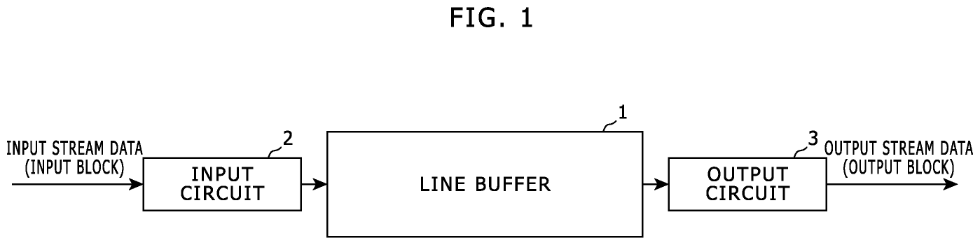

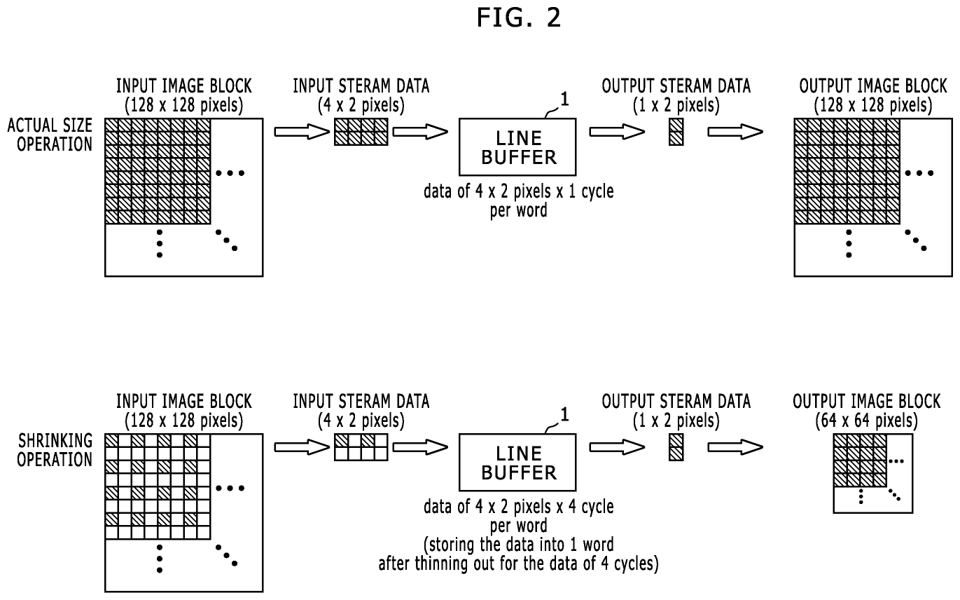

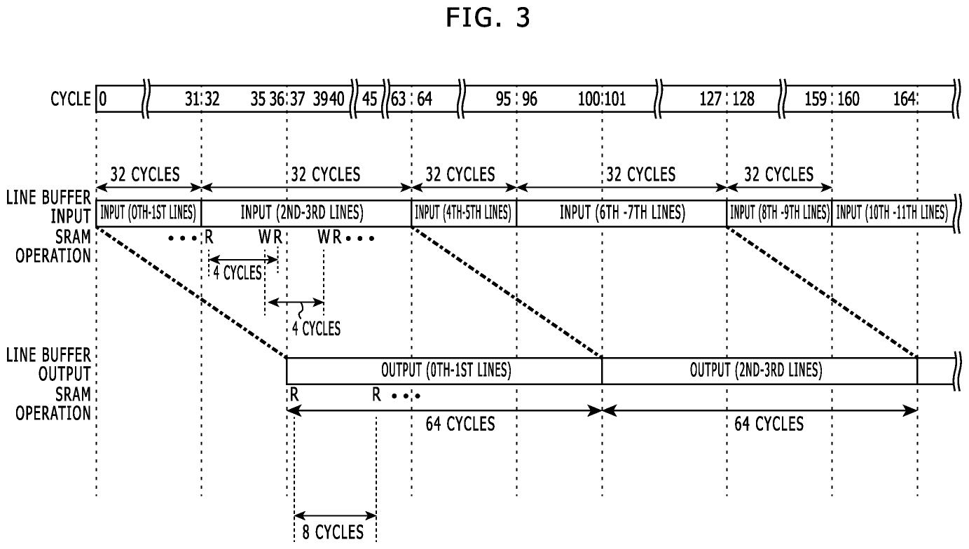

FIG. 1 shows a block diagram that indicates a configuration of an image processing apparatus according to an embodiment of the present disclosure. FIG. 2 shows a diagram that explains an actual size operation and a shrinking operation using a line buffer in the image processing apparatus shown in FIG. 1. FIG. 3 shows a timing chart that explains a shrinking operation using a line buffer in the image processing apparatus shown in FIG. 1.

The image processing apparatus shown in FIG. 1 includes a line buffer 1, an input circuit 2, an output circuit 3, and a controller 4. In this embodiment, the line buffer 1 is a predetermined memory area allocated in an SRAM (Static Random Access Memory), and this SRAM is a one-port (one read/write port) SRAM enabled to performs only one of a read operation and a write operation from/to the line buffer 1 per cycle of a clock.

The input circuit 2 writes pixel data into the line buffer 1. Specifically, as shown in FIGS. 2 and 3, for example, with a throughput obtained by multiplying a throughput (i.e. a rate of read/write) of the output circuit 3 by a square of an inverse number of the shrinking ratio (e.g. by 4 if the shrinking ratio in vertical and horizontal directions is ½), the input circuit 2 skips another pixel than the pixel to be sampled among the pixel data of an input block of a predetermined size (e.g. a block of 4 by 2 pixels) that extends over lines of an inverse number of the shrinking ratio (e.g. over 2 lines if the shrinking ratio in vertical and horizontal directions is ½), and writes pixel data of the pixel to be sampled into the line buffer 1.

The pixel to be sampled is specified correspondingly to a shrinking ratio, the output circuit 3 reads pixel data of the specified pixel among the pixel data. Specifically, as shown in FIGS. 2 and 3, for example, upon writing pixel data of an adjacent input block of the input block in a secondary scanning direction into the line buffer 1, the output circuit 3 reads from the line buffer 1 the pixel data of the pixel to be sampled and continuously outputs the pixel data.

Further, in this embodiment, as shown in FIG. 2, for example, the input circuit 2 writes into one word of the line buffer 1 image data of pixels to be sampled in predetermined plural input blocks (input blocks of the same number as an inverse number of the shrinking ratio, e.g. 4 blocks), and the output circuit 3 reads the image data of the pixels to be sampled word by word and continuously outputs the image data. In a case shown in FIG. 3, when an input block in a head part of the second and third lines (4 by 2 pixels) is inputted, an output block of the zero-th and first lines (1 by 2 pixels) in output corresponding to input of the zero-th to third lines.

Further, the controller 4 selectively specifies one of an actual size operation and a shrinking operation to the input circuit 2 and the output circuit 3. The input circuit 2 (a) in the actual size operation, writes the pixel data of the input block into the line buffer without skipping a pixel, and (b) in the shrinking operation, skips another pixel than the pixel to be sampled among the pixel data of an input block of a predetermined size that extends over lines of an inverse number of the shrinking ratio, and writes pixel data of the pixel to be sampled into the line buffer 1. The output circuit 3 continuously reads the image data of the pixels to be sampled both in the actual size operation and in the shrinking operation.

It should be noted that the controller 4 may perform a hardware process to control the input circuit 2 and the output circuit 3, or may perform a software process to control the input circuit 2 and the output circuit 3.

The following part explains a behavior of the aforementioned image processing apparatus.

The controller 4 specifies the shrinking operation to the input circuit 2 and the output circuit 3 if a shrunk image is required in a subsequent processing unit, and specifies the actual size operation to the input circuit 2 and the output circuit 3 if the line buffer 1 is used but a shrunk image is not required in a subsequent processing unit (e.g. line delay, a window-referring image process such as a filter process without image shrinking).

In a case shown in FIGS. 2 and 3, for example, the input circuit 2 reads image data of every input block of 4 by 2 pixels per cycle of a clock in turn along a primary scanning direction from an input image block of 128 by 128 pixels; and if the actual size operation is specified, the input circuit 2 writes the image data of the input block of 4 by 2 pixels, as is, into one word of the line buffer 1, and if the shrinking operation (with a shrinking ratio of half) is specified, the input circuit 2 skips a part of the image data of the input blocks of the 4 by 2 pixels for four cycles and writes the image data of 8 pixels to be sampled into one word of the line buffer 1.

Subsequently to a last input block in the primary scanning direction, a top input block in the primary scanning direction is read of two lines adjacent in the secondary scanning direction.

In this embodiment, pixel data of the input image block is stored in a predetermined memory area of the aforementioned SRAM, and is read from the memory area and written into the aforementioned memory area of the line buffer 1. Specifically, as shown in FIG. 3, for example, the input circuit 2 (a) sequentially reads the pixel data from another memory area than the memory area of the line buffer 1 in the aforementioned SRAM with a predetermined first period (here, 4 cycles) (in FIG. 3, at the 32nd, 36th, . . . cycles), and (b) writes the pixel data into the memory area of the line buffer 1 with the predetermined first period at a timing different from a timing of reading the pixel data from the another memory area (at a different cycle) (in FIG. 3, at the 35th, 39th, . . . cycles); and the output circuit 3 reads the pixel data from the memory area of the line buffer 1 at a timing different from both the timing of reading the pixel data from another memory area and a timing of writing the pixel data into the other memory area, with a predetermined second period (an integral multiplication of the first period, here 8 cycles) (in FIG. 3, at the 37th, 45th, . . . cycles).

In this case, every 8 cycles of the clock, the output circuit 3 reads the image data of 8 by 2 pixels (for two words) into the line buffer 1 in synchronization with the input circuit 2, and continuously outputs the output block of 1 by 2 pixels per cycle of the clock.

Consequently, the pixel data is continuously outputted even in the shrinking operation as shown in FIG. 3, for example.

As mentioned, in the aforementioned embodiment, with a throughput obtained by multiplying a throughput of the output circuit 3 by a square of an inverse number of the shrinking ratio, the input circuit 2 skips another pixel than the pixel to be sampled among the pixel data of an input block of a predetermined size that extends over lines of an inverse number of the shrinking ratio, and writes pixel data of the pixel to be sampled into the line buffer 1; and upon writing pixel data of an adjacent input block of the input block in a secondary scanning direction into the line buffer 1, the output circuit 3 reads from the line buffer 1 the pixel data of the pixel to be sampled and continuously outputs the pixel data.

Consequently, the image shrinking is performed as a hardware process without suspension of line output.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, the shrinking ratio is set as half. Alternatively, the shrinking ratio may be set as another value (i.e. quarter).

Further, in the aforementioned embodiment, the number of pixels of pixel data stored in one word of the line buffer is not limited to that as mentioned.

What is claimed is:

1. An image processing apparatus, comprising:
a line buffer;
an input circuit configured to write image data into the line buffer; and
an output circuit configured to read pixel data of a pixel to be sampled among the pixel data, the pixel specified correspondingly to a shrinking ratio;
wherein with a throughput obtained by multiplying a throughput of the output circuit by a square of an inverse number of the shrinking ratio, the input circuit skips another pixel than the pixel to be sampled among the pixel data of an input block of a predetermined size that extends over lines of an inverse number of the shrinking ratio, and writes pixel data of the pixel to be sampled into the line buffer; and upon writing pixel data of an adjacent input block of the input block in a secondary scanning direction into the line buffer, the output circuit reads from the line buffer the pixel data of the pixel to be sampled and continuously outputs the pixel data.

2. The image processing apparatus according to claim 1, wherein the input circuit writes into one word of the line buffer image data of pixels to be sampled in predetermined plural input blocks; and
the output circuit reads the image data of the pixels to be sampled word by word and continuously outputs the image data.

3. The image processing apparatus according to claim 1, wherein the line buffer is one-port SRAM;
the input circuit (a) sequentially reads the pixel data from another memory area than the memory area of the line buffer with a predetermined first period, and (b) writes the pixel data into the memory area of the line buffer with the predetermined first period at a timing different from a timing of reading the pixel data from the another memory area; and
the output circuit reads the pixel data from the memory area of the line buffer at a timing different from both the timing of reading the pixel data from the other memory area and a timing of writing the pixel data into the other memory area, with a predetermined second period that is an integral multiplication of the first period.

4. The image processing apparatus according to claim 1, further comprising a controller;
wherein the controller selectively specifies one of an actual size operation and a shrinking operation to the input circuit and the output circuit;
the input circuit (a) in the actual size operation, writes the pixel data of the input block into the line buffer without skipping a pixel, and (b) in the shrinking operation, skips another pixel than the pixel to be sampled among the pixel data of an input block of a predetermined size that extends over lines of an inverse number of the shrinking ratio, and writes pixel data of the pixel to be sampled into the line buffer; and
the output circuit continuously reads the image data of the pixels to be sampled both in the actual size operation and in the shrinking operation.
